(19) United States
(12) Patent Application Publication
(10) Pub. No.: US 2025/0274722 A1
(43) Pub. Date: Aug. 28, 2025

(54) Inventory System for Mines

(71) Applicant: Peytec Inc., Richmond Hill (CA)

(72) Inventors: Peyman MOEINI, Thornhill (CA); Anand SINHA, Dundas (CA); Akbar AHMARI, Concord (CA); Sorin HOGIU, Oakville (CA); Sammy GUERGACHI, North York (CA); Ovice SADRMAHDAVI, North York (CA)

(21) Appl. No.: 18/855,991

(22) PCT Filed: Apr. 11, 2022
(86) PCT No.: PCT/CA2022/000026

§ 371 Date: Oct. 10, 2024

(51) Int. Cl. H04W 4/029; E21F 17/18; G06Q 10/087; H04W 4/02

(52) U.S. Cl. CPC H04W 4/029; E21F 17/18; H04W 4/023; G06Q 10/087

(57) ABSTRACT

The system includes beacons, readers, controllers, a display and connectivity. The beacons: are selectively actuable; have unique identifiers; when active, receive a type; when active and in motion, emit a signal including identifier and type; when active, periodically emits the signal. Readers: receive signals; identify beacons that have attained proximity. Controllers: receives signals; identifies beacons that attained proximity; have programmable logic and a relay responsive thereto and signals. The display displays: zones associated with readers and controllers; active beacons in zones, the entry of beacon into zones being associated with that beacon having attained proximity to the associated reader or controller; active beacons not in a zone. The connectivity: receives from the controllers and readers the identifiers of beacons determined to have attained proximity thereto and deliver same to the display; permits users to associate a type and a location to an identifier and write a type to a beacon.

### FIELD

The invention relates to the field of mining.

### BACKGROUND

In a typical mining operation, mineral extraction involves blasting rock to create blocks, converting the blocks into smaller fragments (muck) for transport and transporting the muck to a processing area where the valuable components are extracted via chemical and physical processes.

Transporting the muck can get very complex; in large mines, there are many transport routes can be tens of kilometers in length and can be above and below the surface. Further complicating matters, the origin of muck matters: some muck contains economically important quantities of valuable components; some does not; and the valuable muck is often visually indistinguishable from the remainder. Yet further complicating matters is the difficulty of maintaining muck identity: in a typical mine, a muck pile can be mixed with other piles in transit. Muck piles are also sometimes stored in random locations.

The above complications are not merely minor inconveniences: a mischaracterized load in a truck can represent the loss of many thousands of dollars.

### SUMMARY OF THE INVENTION

Forming one aspect of the invention is an inventory management system for a mine, the system comprising beacons, readers, controllers, a display system and a connectivity system.

Each beacon is functionalized as follows: selectively actuable; has a unique identifier; when active, adapted to receive a type; when active and in motion, emits a signal including identifier and received type; when active, periodically emits the signal.

Each reader is functionalized as follows: receives signals emitted by beacons; identifies beacons that are determined to have attained a proximity to the reader based upon signals received.

Each controller is functionalized as follows: receives signals emitted by beacons; identifies beacons that are determined to have attained a proximity to the controller based upon signals received; has a programmable logic; has relays responsive to the logic and the signals received.

The display system is functionalized as follows: displays zones, each zone being associated with a reader or a controller; displays active beacons in each zone, the entry of a beacon into a zone being associated with that beacon having been determined to have attained the proximity to the reader or controller associated with that zone; displays active beacons not in a zone.

The connectivity system functionalized as follows: adapted to receive from the controllers and the readers the identifiers of the beacons determined to have attained proximity thereto and deliver same to the display; adapted to permit a user to associate a type and a location to an identifier; adapted to write a type to a beacon.

According to another aspect, the system can further comprising handhelds, each handheld being functionalized as follows: receives signals emitted by beacons; identifies beacons that are determined to have attained a proximity to the handheld based upon signals received.

According to another aspect, the connectivity system can include: an app, the app in use functionalizing phones.

According to another aspect, the app can functionalize phones to.
adapt the phone to permit a user to write the type to the beacon as aforesaid
adapt the phone to permit a permit a user to associate a type, a location and notes to an identifier
adapt the phone to permit a permit a user to associate a type, a location and notes to an identifier via manual entry to the phone and subsequent transmission by internet to the display system
adapt a phone to:
   receive from a handheld details of the beacons identified to have attained proximity thereto;
   display the details of the beacon on the phone;
   permit a user to store an updated location of the beacon; and
   deliver the updated location of the beacon to the display system.

According to another aspect, the beacon can be actuable by a magnet.

According to another aspect, the beacon can have a low power state, an active state and a magnet switch and is adapted such that, when a magnet attains proximity to the magnet switch when beacon is in the low power state, the beacon converts to the active state.

According to another aspect, the signal can further includes a battery strength.

According to another aspect, the readers and controllers can be functionalized to filter and control the flow of received beacon data.

According to another aspect, the display system can be further functionalized to display beacon detail change history.

According to another aspect, the connectivity system can be further functionalized to permit an authorized user to change beacon details are association.

Advantages, features and characteristics of the present invention will become apparent upon review of the following detailed description with reference to the appended drawings, the latter being briefly described hereinbelow.

### BRIEF DESCRIPTION OF THE DRAWINGS

FIG. 1 is a partially schematic view showing an example embodiment of the invention deployed in a stylized mine;

FIG. 2 is an enlarged view of encircled area 2 on FIG. 1;

FIG. 3 is an enlarged view of encircled area 3 on FIG. 1;

FIG. 4 is an enlarged view of encircled area 4 on FIG. 1;

FIG. 5 is an enlarged view of encircled area 5 on FIG. 1;

FIG. 6 is an enlarged view of encircled area 6 on FIG. 1;

FIG. 7 is a view similar to FIG. 6;

FIG. 8 is a view showing activation of the apparatus of FIG. 2;

FIG. 9 is a view of a display produced on a functionalized phone by the app;

FIG. 10 is a view showing a functionalized phone scanning a beacon;

FIG. 11 is a view of another GUI produced on a functionalized phone;

FIG. 12 is a view of another GUI produced on a functionalized phone;

FIG. 13 is a view showing a functionalizing phone writing a type to a beacon;

FIG. 14 is a view of another display produced on a functionalized phone by the app;

FIG. 15 is a view of handheld before connecting to a functionalized phone by the app;

FIG. 16 is a view of handheld after connected to a functionalized phone by the app;

FIG. 17 is a view of GUI produced on a functionalized phone before user authentication;

FIG. 18 is a view of an example GUI produced after user is authenticated;

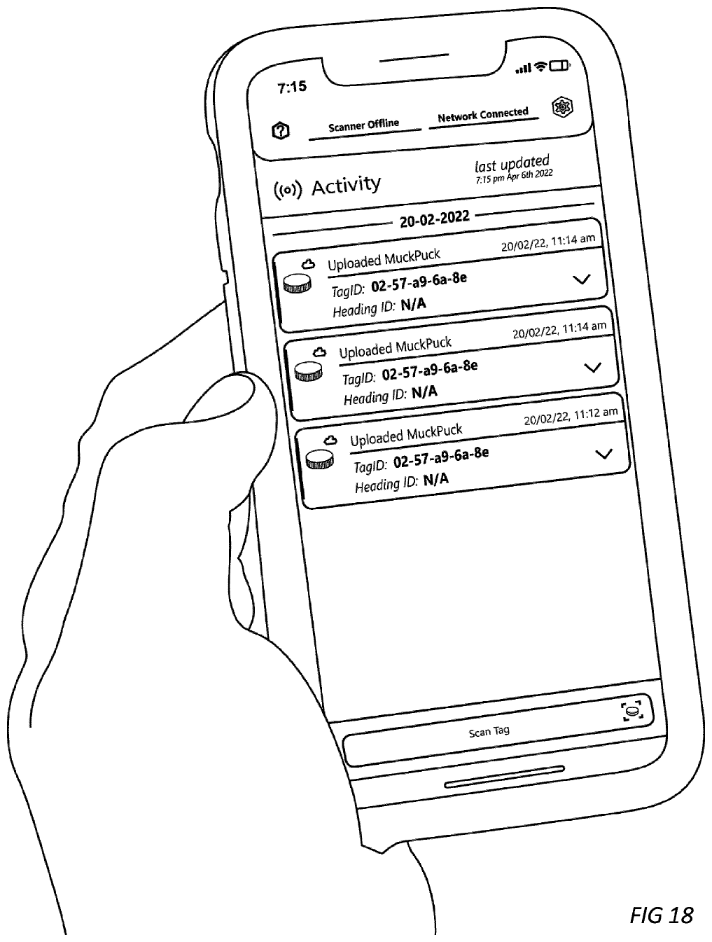

FIG. 19 is another view of the GUI produced on a functionalized phone;

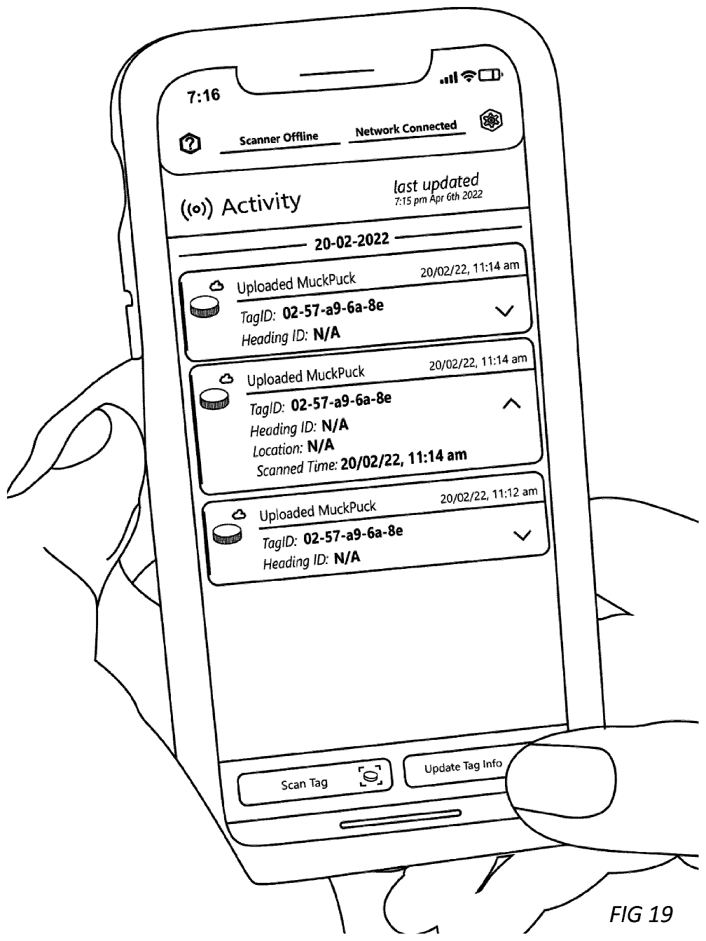

FIG. 20 is another view of the GUI produced on functionalized phone;

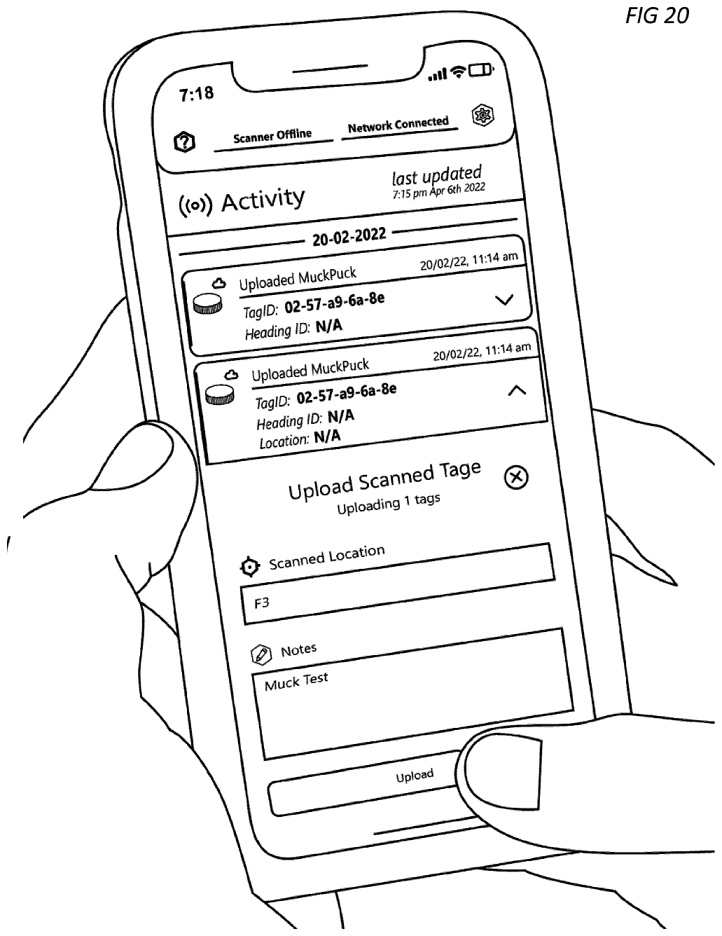

FIG. 21 is a GUI view of historical changes of a beacon detail;

FIG. 22 is simplified view of the FIG. 1 system connections;

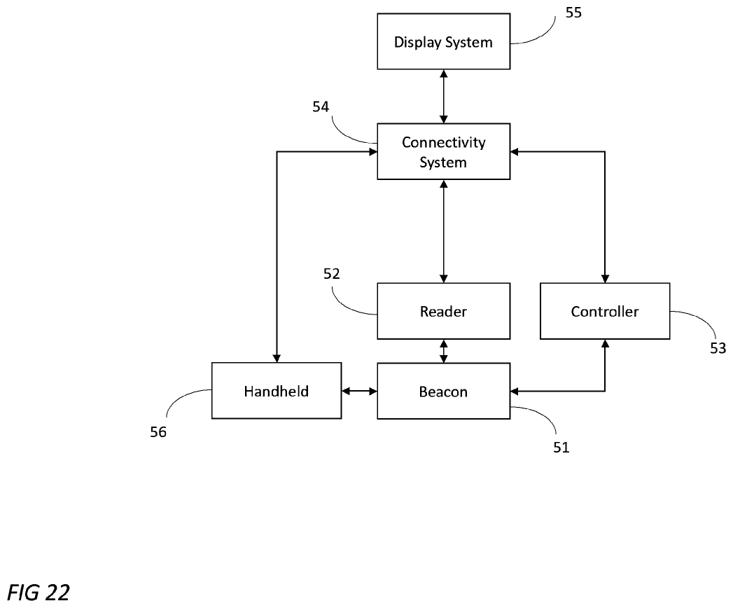

FIG. 23 is an explosive view of beacon shown in FIG. 2;

FIG. 24 is the beacon electronics and embedded architecture of FIG. 2; and

FIG. 25 is a GUI view of a beacon details and location history.

### DETAILED DESCRIPTION

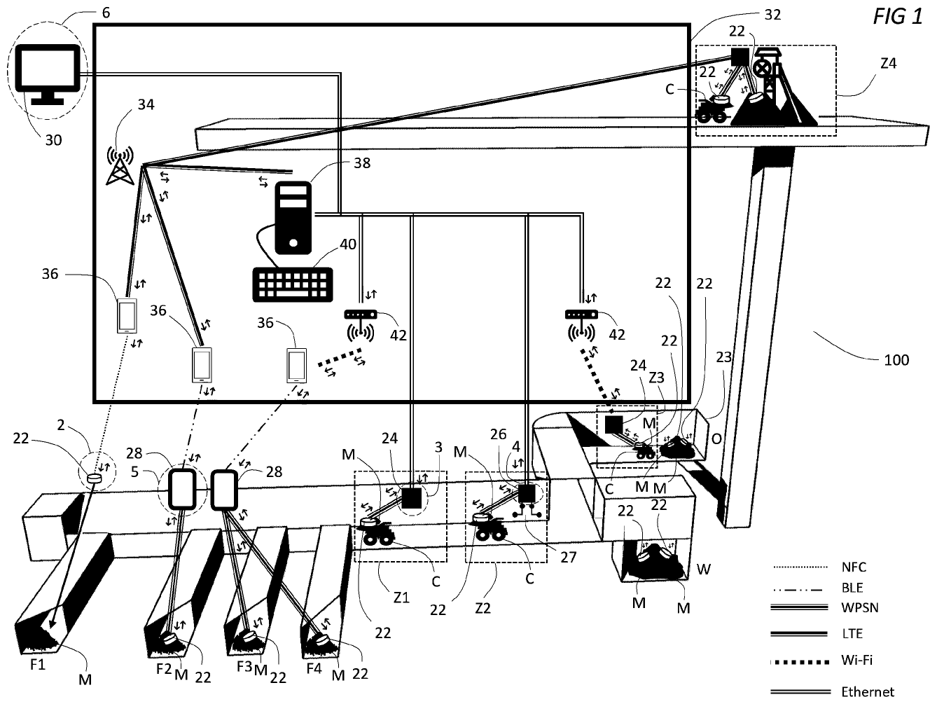

An example inventory management system according to the present invention is shown in partial schematic stylized form in FIG. 1 as deployed in a stylized mine 100.

### Overview of the Mine

The mine 100 will be seen to include, inter alia, zones Z1, Z2, Z3, Z4 muck piles M, a waste area W, an ore area O, flights F1, F2, F3, F4, and carts C. The zones Z1, Z2, Z3, Z4 will be understood to be areas within the mine, such as corridors or rooms. The muck piles M will be understood to be piles of material extracted during the mining process having varying amounts of valuable material therein. The flights F1, F2, F3, F4 will be understood to be passages created during the course of mining. The waste area W is a place within the mine where piles having little valuable material are deposited. The ore area O is a place within the mine where a pile having sufficient value material therein to be further processed is deposited. The carts C carry the piles through the mine.

### The System

The example system will be understood to utilize a proprietary RF communication system known as Wireless Positioning and Sensing Network (WPSN) and to include beacons 22, readers 24, controllers 26, handhelds 28, a display system 30 and a connectivity system 32.

### WPSN

WPSN is a Medium Access Control (MAC) layer system with low latency, high security, low bit rate, low power, high communication range, geolocation capability and statistically adaptive throughput characteristics designed to manage communication and localization of highly unpredictable Wireless Sensor Networks (WSNs). The communication protocol utilizes a XOR encryption to keep the packet lengths minimal while ensuring the wireless signals are not easily decodable. The manner in which localization is done is readily understood by persons of ordinary skill in the art and as such, further detail is neither provided nor required. In more detail, WPSN is a semi-slotted ALOHA constrained with slot duration which is adjusted based on the environmental conditions. The start of a transmission is anytime during a randomized slot while the transmission can leak outside of the boundary of the slot. The methodology allows for receive commands but does not seek an acknowledgement as the reliability of the WPSN network is mitigated through time diversity. The receiver of the WPSN network decrypts the received signals while it is checking for the integrity and reliability of the received data through a checksum. The time diversity means the WPSN networks repeats broadcasting a signal multiple time. The times of transmissions are randomly generated based on proposed the semi-slotted ALHOA protocol. The WPSN signals are narrow band to maximize the signal-to-noise ratio. Since the networks are not sensed before a transmission. The randomized nature of the transmissions minimizes interference.

### Beacons

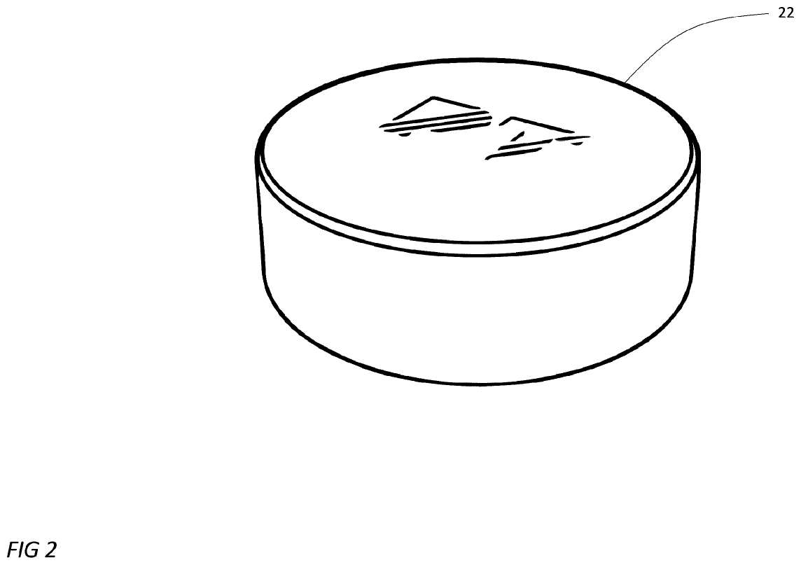

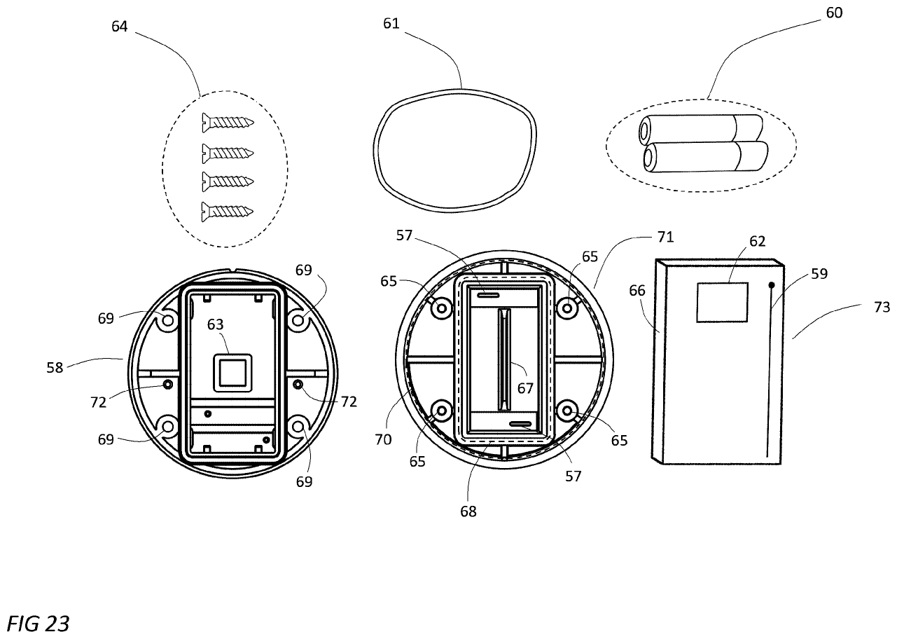

With reference to FIG. 2, and FIG. 23, each beacon 22 is a ruggedized device having externally a base shell 71, a top shell 58, and screws 64 and interiorly an electronic circuit 73, batteries 60, and a cascade 61.

### Structure

The batteries 60 are placed inside the battery holder 66. Subsequently, the electronic circuit 73 is placed inside the inner shell 71. Then, the cascade 61 is placed in the gap 68. Then, the upper shell 58 is placed on top of the base shell 71. Then, the screws 64 are screwed go through the holes 69 and penetrate the base holes 65 holding the base shell and the top shell together tightly. The base shell 71 and top shell 58 protect the batteries 60, PCB 59, and battery holder 66 from compression forces. More particularly:
the inner shell 68 which encapsulates the PCB 59, battery holder 66, and batteries 60 is protected from direct compression from the sides by outer shell 70;
the inner shell 68 walls hold the electronic circuit 73 in place and protect it against compression that applied from the top or button of the beacon;
the base shell 71 and top shell 58 protect the batteries 60, PCB 59, and the battery holder 66 from impact forces. More particularly: extrusions 57 absorb the side way shock associated with batteries 60 movement in an event of an impact force ensuring the battery holder 66 or the PCB 59 are protected; and extrusion 63 loosely keeps the PCB 59 in place while foam 62 secures the PCB 59 to top shell 58 to dampen the effect of shock and impact forces;
the cascade 61, base shell 71, top shell 58, and screws 74 protect the protect the electronic circuit 73 and batteries 60 against water and dust; and
the screw holes 69 do not need to be sealed as the cascade 61 is placed in the gap 68, inside relative to the position of the screw holes 65, and 69.

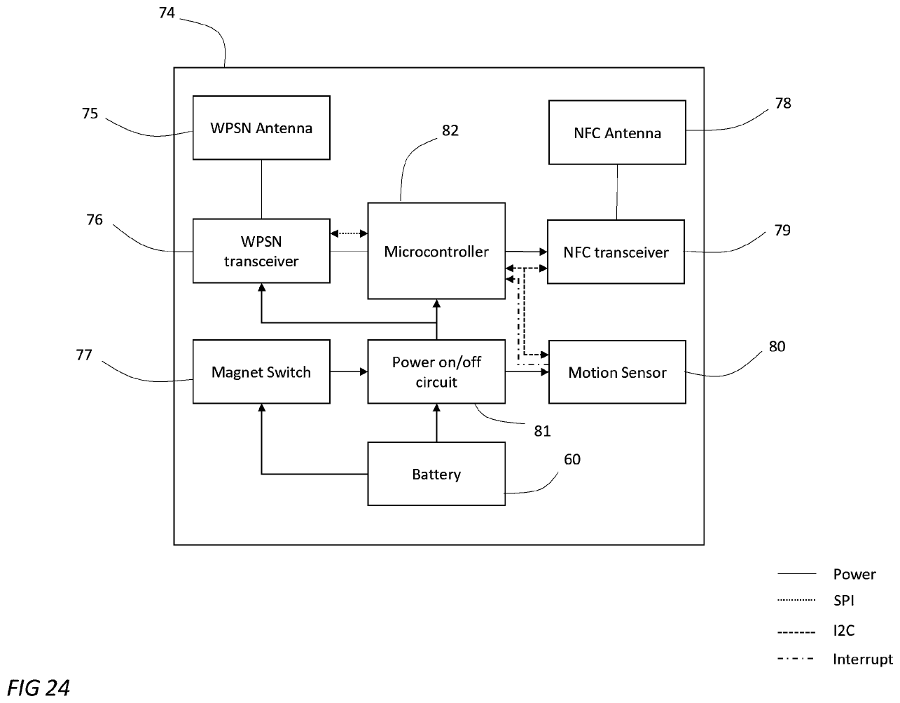

With reference to FIGS. 23 and 24, the architecture 73 of the PCB 59, consists of a microcontroller 74, a WPSN antenna 75, a WPSN transceiver 76, a magnet switch 77, a NFC antenna 78, a NFC transceiver 79, a motion sensor 80, a power on/off circuit 81, and battery 60, all functionalized as follows:
73 has a default ultra low power state, low power state and an active state
is adapted such that, when a magnet attains proximity to the magnet switch 80 when beacon is in the ultra low power state, the power ON/OFF circuit 81 connects the power to the microcontroller and WPSN transceiver which turns converts the beacon to the active state
is adapted such that, when an OFF message command is received through the WPSN antenna 75 to the WPSN transceiver 76, the microcontroller 82 toggles an I/O pin that is connected to the Power on/off circuit 81 which it cuts the power to the microcontroller 81 and magnet switch 77 converting the beacon back to the ultra-low power state.
has a unique identifier
when in active state, adapted to receive via NFC transceiver 79 through the NFC antenna 78a type
when in the low power state, adapted to send a type, state status, and battery strength
periodically emits a WPSN signal including identifier, type and battery strength when in active state
has a status signal responsive to activation and scannable by NFC transceiver 79 through the NFC antenna 78
assumes the low power state on receipt of a master message sent by WPSN transceiver 76 through the transceiver antenna 75.

As illustrated, piles throughout the mine are tagged with beacons. Each active beacon broadcasts a WPSN signal which includes the unique identifier associated with the beacon, a pile type selected from ore and waste and a battery life. The signal is sent periodically at threshold constrained random time intervals. The random interval between signals sent while the beacon is stationary (as determined by the motion sensor) is relatively long in comparison to the random interval between signals sent while the beacon is in motion. The duration of the reading interval in the stationary or motion states is programmable via NFC or WPSN.

### Readers

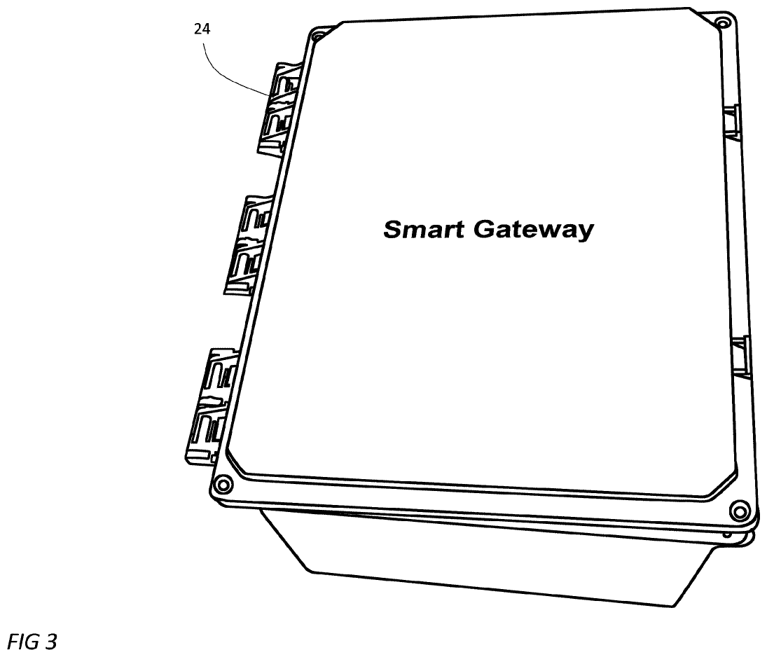

With reference to FIG. 3, each reader 24 is a ruggedized device having interiorly (and not shown) a power source, a microcontroller, memory unit, a WPSN transceiver and a microcontroller, an LTE transceiver, a Wi-Fi transceiver, and Ethernet port all functionalized to:
identify beacons that are determined to have attained a proximity to the reader based upon the WPSN signals
capture identifier, type, battery strength information, and WPSN Received Signal Strength (RSSI) information
[hereinafter, ‘details’] from such beacons.
send commands to beacons by WPSN
temporarily or permanently stores received beacon and diagnosis data.
assigns date and time and timestamp to the beacons that attained proximity to the reader
configures to send and receive data to the connectivity system or only send data to the connectivity system.
decrypts beacon details after receiving it from WPSN
stores data from beacons locally if connectivity system is unavailable otherwise sends data immediately
connectivity system access check to send stored data in time sequencethrottling of data sent when re-accessing connectivity system to prevent overwhelming connectivity system
identifies beacons that have transmitted data to this reader within a configurable time frame, to eliminate replicated data
identifies different versions of beacon for functionality
real-time configuration of logging for troubleshooting
uses key/password authentication to connectivity network for added security
verifies beacon signature to prevent spoofing
health checks to force restart if WPSN is unavailable

It will be understood that the boundary of each zone defined by a reader is defined by the distance over which the WPSN signal of a beacon can be sensed by the reader.

### Controllers

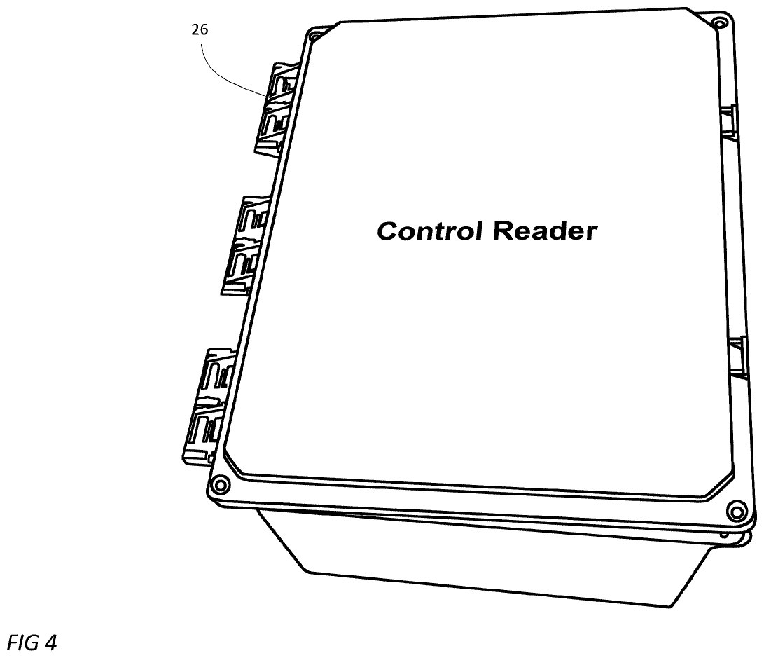

With reference to FIG. 4, each controller 26 is a ruggedized device having interiorly (and not shown) a power source, a microcontroller, memory unit, a WPSN transceiver and a microcontroller, an LTE transceiver, a Wi-Fi transceiver, an Ethernet port, a programmable logic, and a relay, all functionalized as follows:
identifies beacons that are determined to have attained a proximity to the controller based upon the WPSN signals
capture details from such beacons
relay is responsive to the logic and the details
send commands to beacons by WPSN
temporarily or permanently stores received beacon and diagnosis data
assigns date and time and timestamp to the beacons that attained proximity to the reader
configures to send and receive data or only send data to the connectivity system or remain disconnected from the connectivity system decrypts beacon details after receiving it from WPSN
stores data from beacons locally if connectivity system is unavailable otherwise sends data immediately
checks connectivity system access to send stored data in time sequence.
throttling of data sent when re-accessing connectivity system to prevent overwhelming connectivity system
identifies beacons that have transmitted data to this reader within a configurable time frame, to eliminate replicated data
identifies different versions of beacon for functionality
configures real-time logging for troubleshooting
uses key/password authentication to connectivity network for added security
verifies beacon signature to prevent spoofing
health checks to force restart if WPSN is unavailable
verifies programmed state of beacon vs. value stored in database. In the event of conflict, the database version is taken as correct.
can be configured to work without the connectivity system and control the controller actuator based on the received beacon data details and controller local logic. In this configuration a reader can be installed next to a controller where the reader sends data to the connectivity system and the controller controls the actuator logic.

The illustrated controller defines a zone at which signal lighting 27 is deployed and which leads to a branch between the ore pathway O and the waste pathway W. The logic of this controller is programmed to trigger the lighting responsive to the type details of a beacon.

### Handhelds

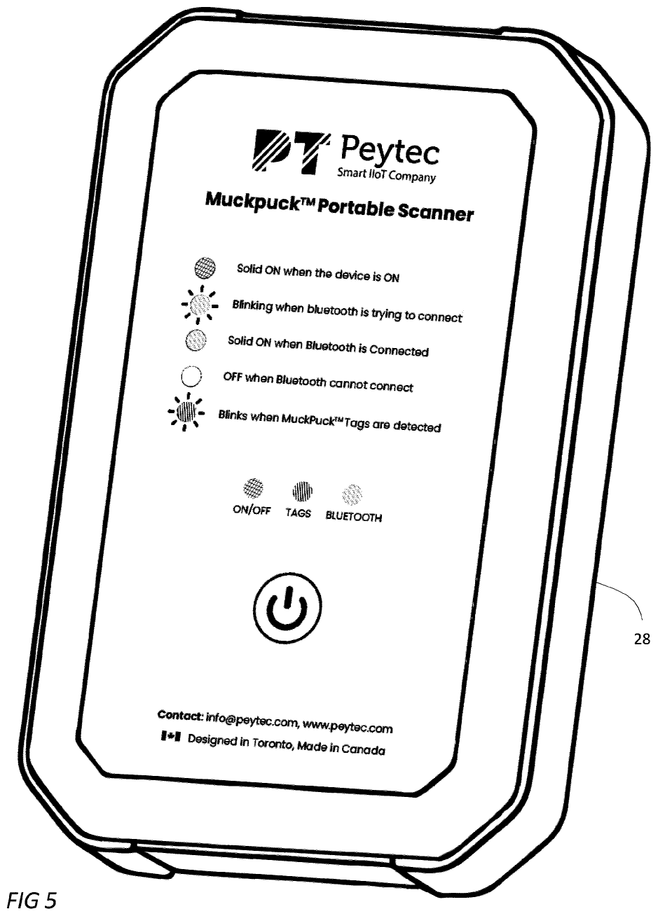

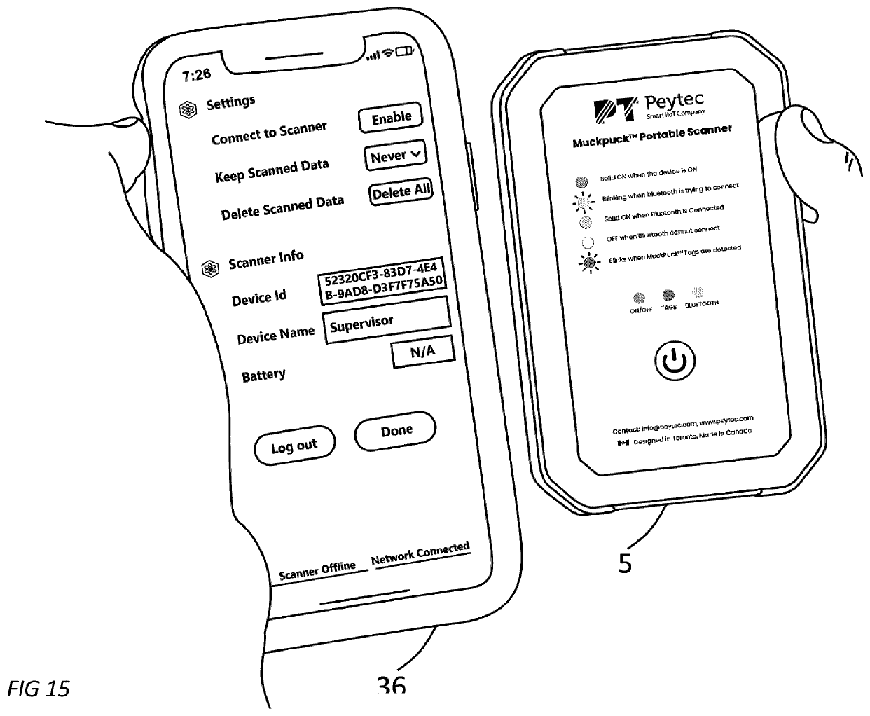

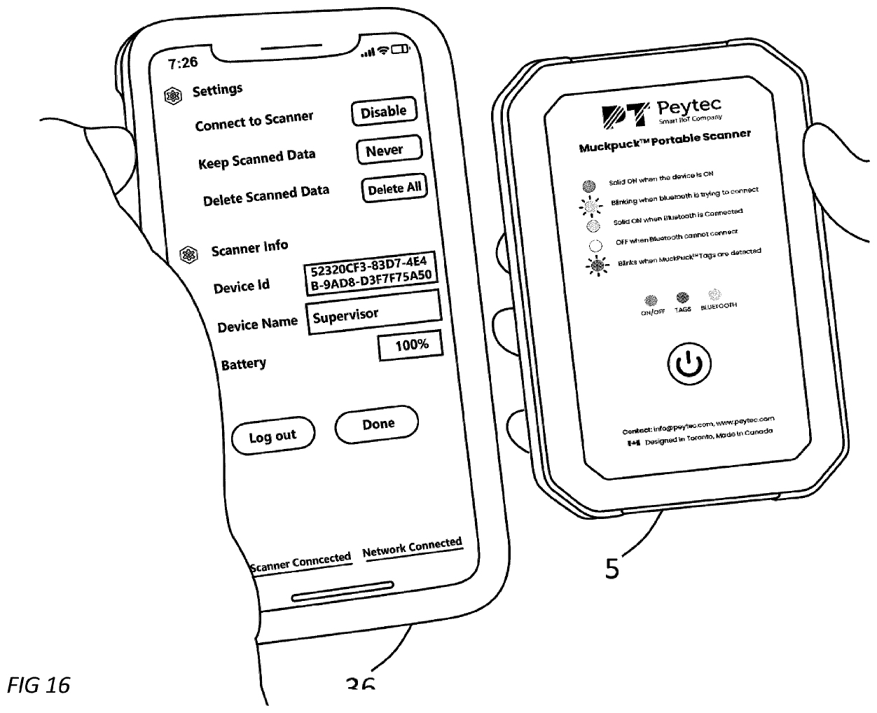

With reference to FIG. 5, FIG. 15, and FIG. 16, each handheld 28 is a ruggedized device having interiorly (and not shown) a battery, a microcontroller, a WPSN transceiver, real-time clock, memory, and a Bluetooth transceiver, all functionalized as follows:
identifies beacons that are determined to have attained a proximity to the handheld based upon the WPSN signal
capture details from such beacons
measures Received Signal Strength (RSSI)
compresses and controls the flow of received beacon data
temporarily or permanently stores received beacon and diagnosis data
assigns date and time and timestamp to the beacons that attained proximity to the handhelds in the absence of an app
displays handheld operation, Bluetooth transceiver connectivity, and WPSN communication status via visual LED indicators
sends handheld status data to the connectivity system via an app
connects, disconnects, and subsequently communicate to the connectivity system via an app
does not assign date and time stamp to the received beacons identified while the handheld is connected to the connectivity system via an app and defers it to connectivity system to assign the date and time stamps
sends to connectivity system its battery level

### Display System

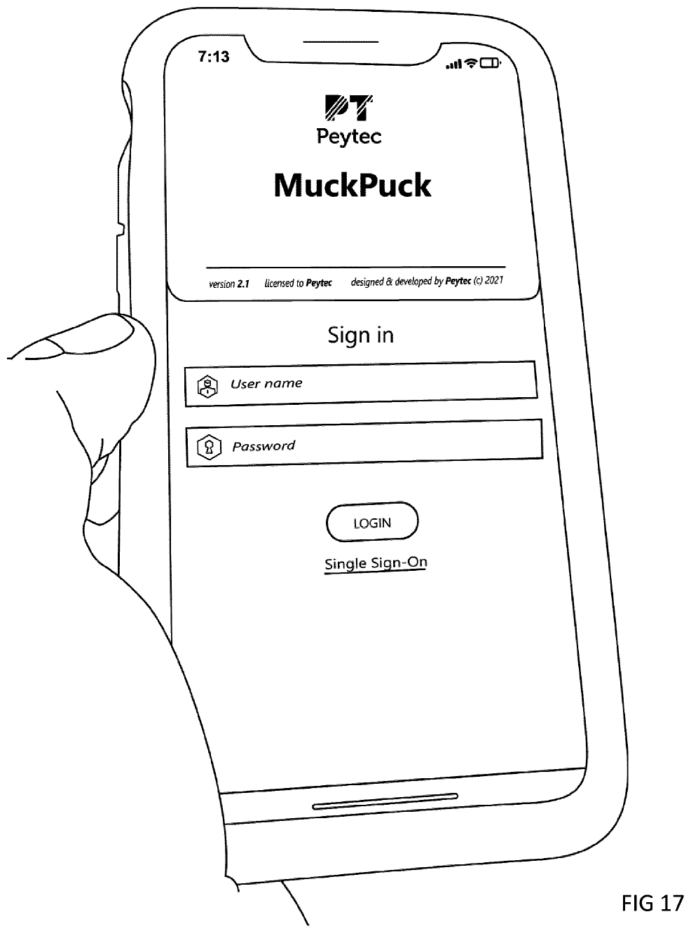

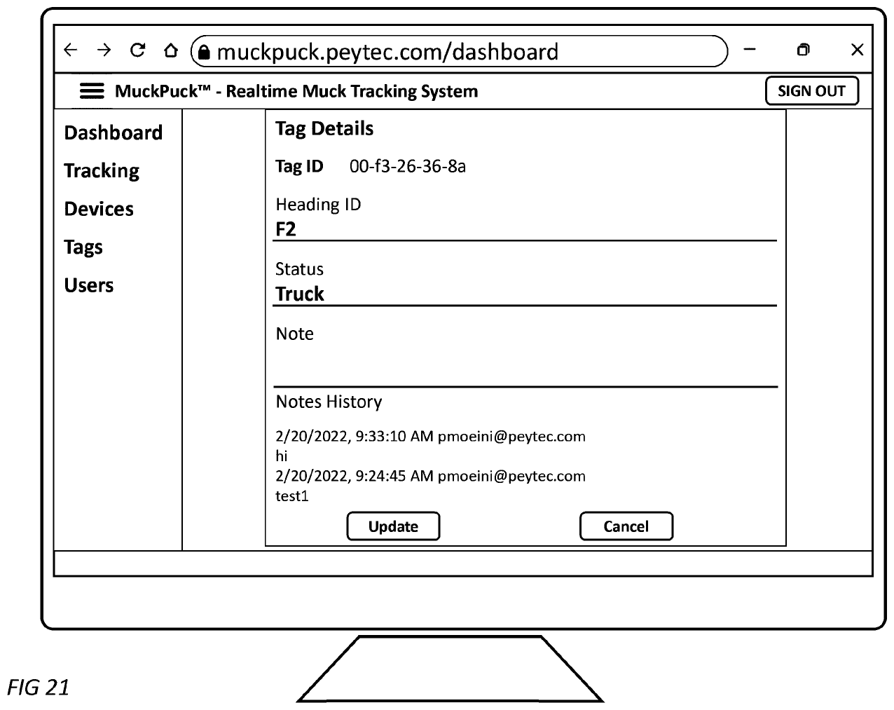

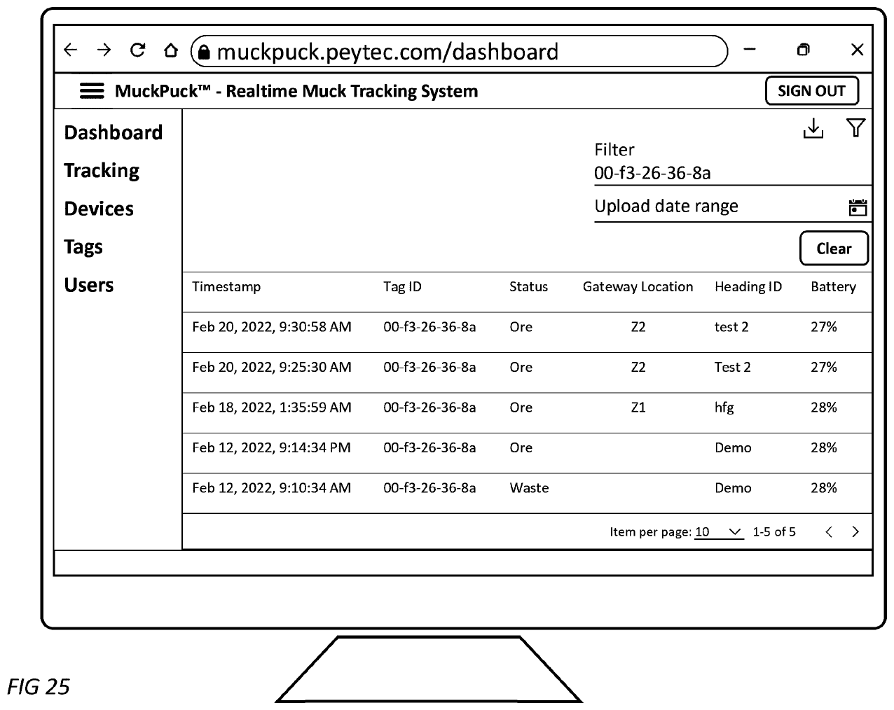

The display system 30 is functionalized as follows:
displays zones [each zone as aforesaid being defined by a reader or a controller]
displays active beacons in each zone, the entry of a beacon into a zone being defined by the identification of the beacon that has attained the proximity to a reader or gateway, the exit of a beacon from a zone being defined by the entry of the beacon into another zone
displays active beacons not in a zone
displays the last time an active beacon was detected by a reader or controller after the beacon entered a zone as shown in FIG. 21
displays beacons' routing data in a spreadsheet format with search capability as per FIG. 25 permits authorized users to downloads beacons' historical data in a spreadsheet by clicking on 83 as per FIG. 25
permits authorized users to change beacon details after association and displays the name of the authorized person who made the change, date and time of the change, in addition to the details of the change as per FIG. 21.
The authorized users are identified as they need to login to cell phones functionalized by an app as shown in FIG. 17 or through the display system (not shown).

### Connectivity System

With reference to FIG. 1, the exemplary connectivity system 32 will be seen to include a subsurface (private) cellular tower 34, cell phones functionalized by an app 36, a server 38, a keyboard 40, Wi-Fi hubs 42, Ethernet cabling [identified on the legend], and should be understood to be functionalized as follows:
the server receives from the controllers and the readers, via Ethernet, Wi-Fi signal and LTE signal, where available, the details of the beacons identified to have attained proximity thereto and delivers said details to the display
functionalized phones: receive from the handhelds via Bluetooth signal the details of the beacons identified to have attained proximity thereto, display the details of the beacon on the phone; permit a user to locally store an updated location of the beacon; deliver the updated location of the beacon to the server and then to the display when the phone attains internet connectivity
adapted to permit a user to associate, through the use of the app and a functionalized phone, an origin, a type, a location and notes to an identifier
adapted to cause a functionalized phone to write an associated type to a beacon via NFC
adapted to associate beacon identifier and its details received via the controllers and readers to the beacon identifier and its details received from a functionalized phone by a user
adapted to filter the received beacon details from the controllers and the readers to only display the beacon entrance and exit or last scan date and time in a zone.
adapted to track the details of any modifications to a beacon such as the user who made the modification, date and time of the modifications and send it to the display system.

### Use

### Inventory Overview

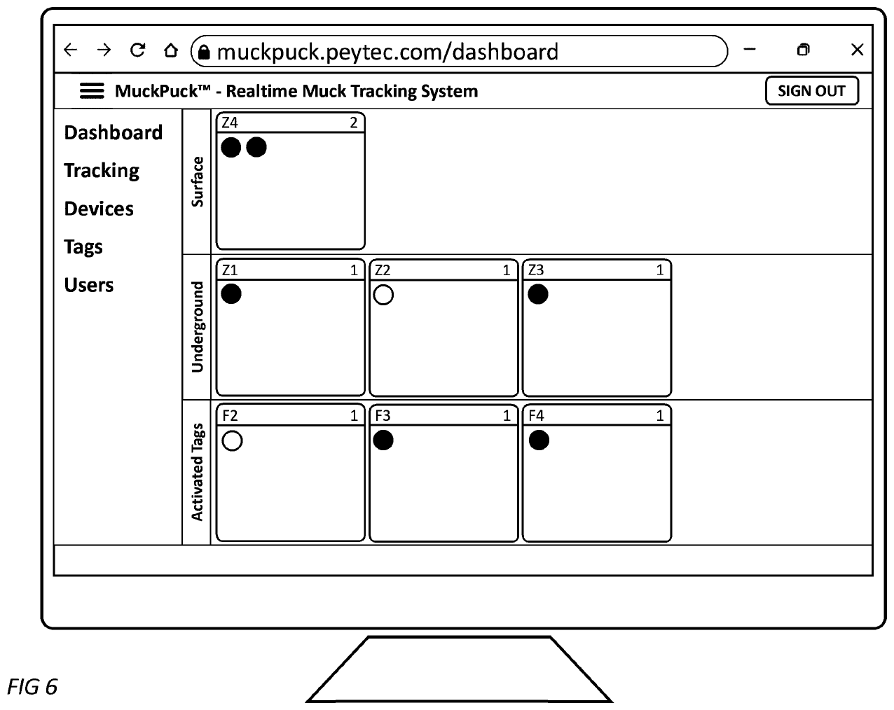

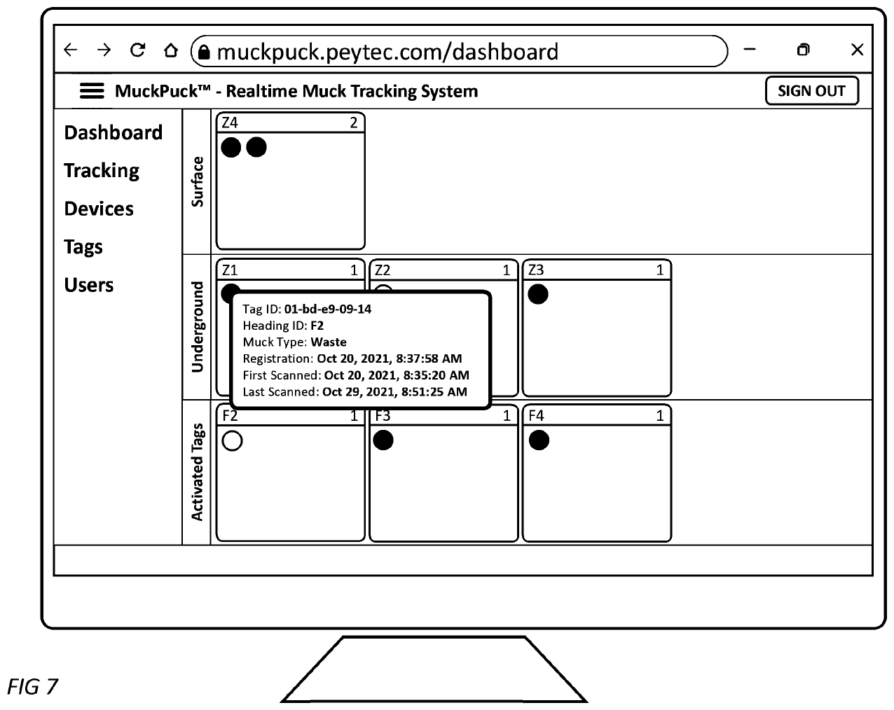

One aspect of the utility of the system will be evident upon the enlarged view of the display shown in FIG. 6 and FIG. 7. Herein, it will be seen that on the display, the lowest row is titled Activated Tags and three records are shown, each representing one of Flights F2, F3 and F4. In each flight, an icon appears representative of the beacon shown therein, the colors of the icons shown in the zones signify that the type of material. A row or level above is titled

Underground wherein it will be seen that records for zones Z1, Z2, and Z3 are shown, again, each with a single colored icon indicating the presence of a single pile and a number at the top right hand of each zone that indicates the total number of active beacons present in a zone. The uppermost row or level is titled Surface and shows a record for zone Z4 and two icons therein, representing the two piles that are in that zone. Thus, the system generally allows a mine supervisor to understand the inventory situation in the mine. FIG. 7 shows the result of selecting an icon on the screen, namely, the retrieval of information about the pile, namely, origin and type, the date and time the first time the active beacon attained a proximity to the reader in zone Z1 and the last time the beacon attained a proximity to the reader in zone Z1 before exiting to a another zone

### Pile Origination

Whereas the above description contemplated that piles are tagged with beacons, it will be appreciated that in order for a pile to have a beacon puck in it, a beacon must first be placed into it. This is done by mine personnel whenever a pile needs to be added to inventory, i.e. when a new pile is created in the mining operation.

### Deploying a Beacon Involves:

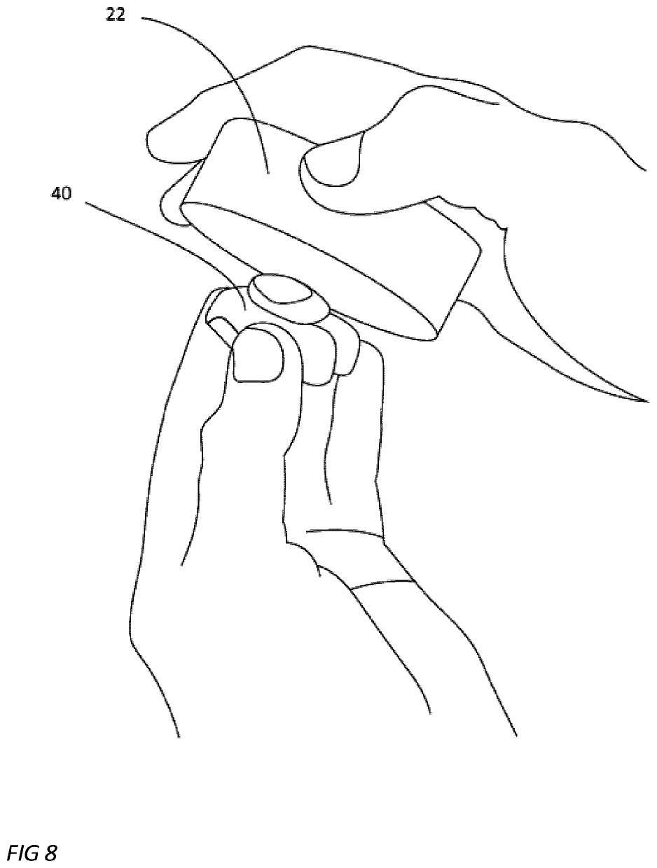

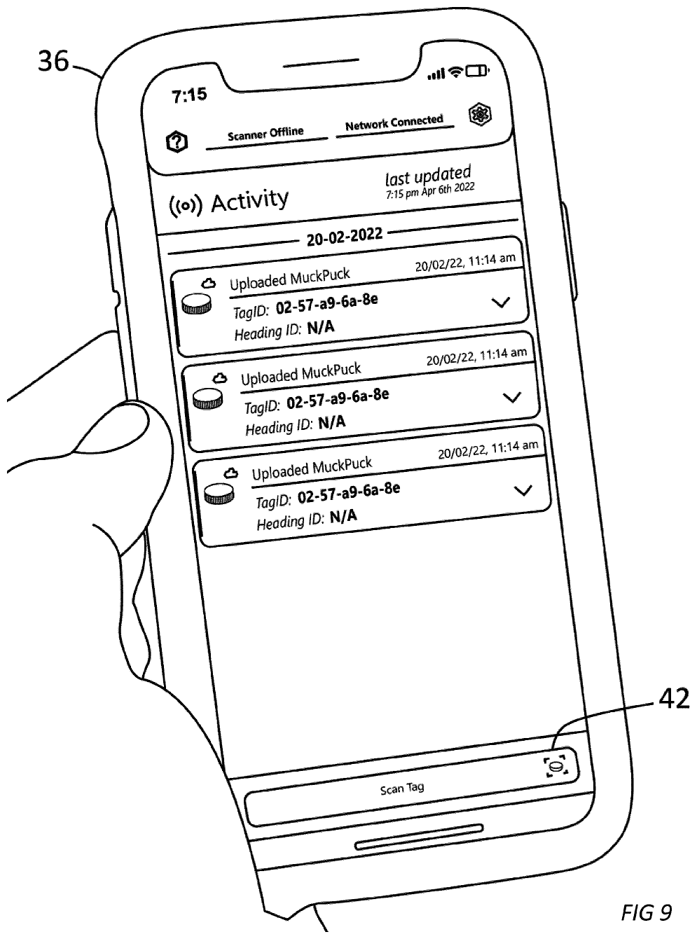

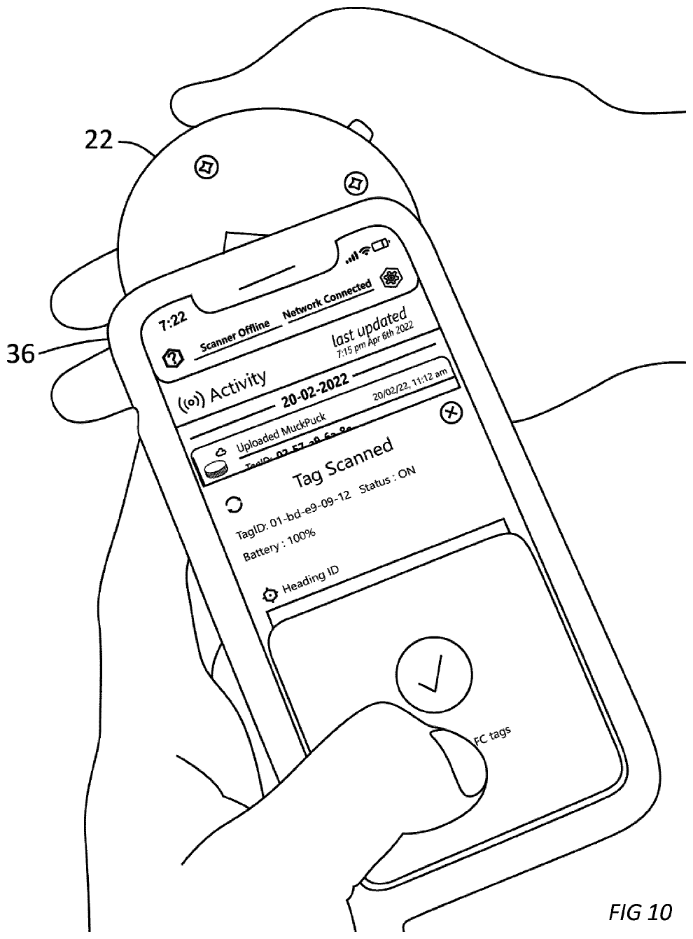

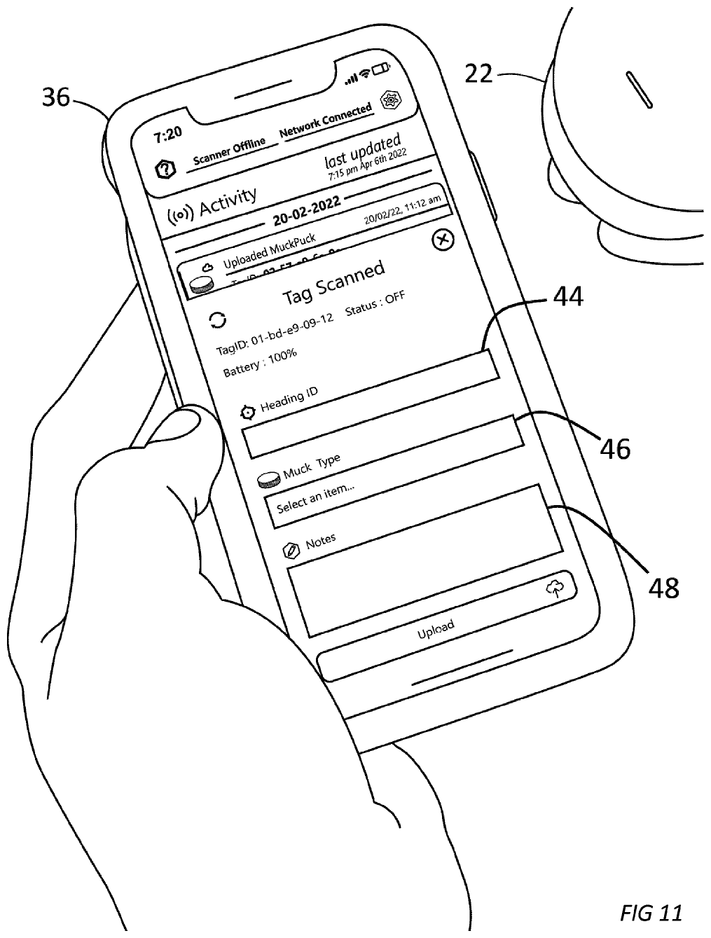

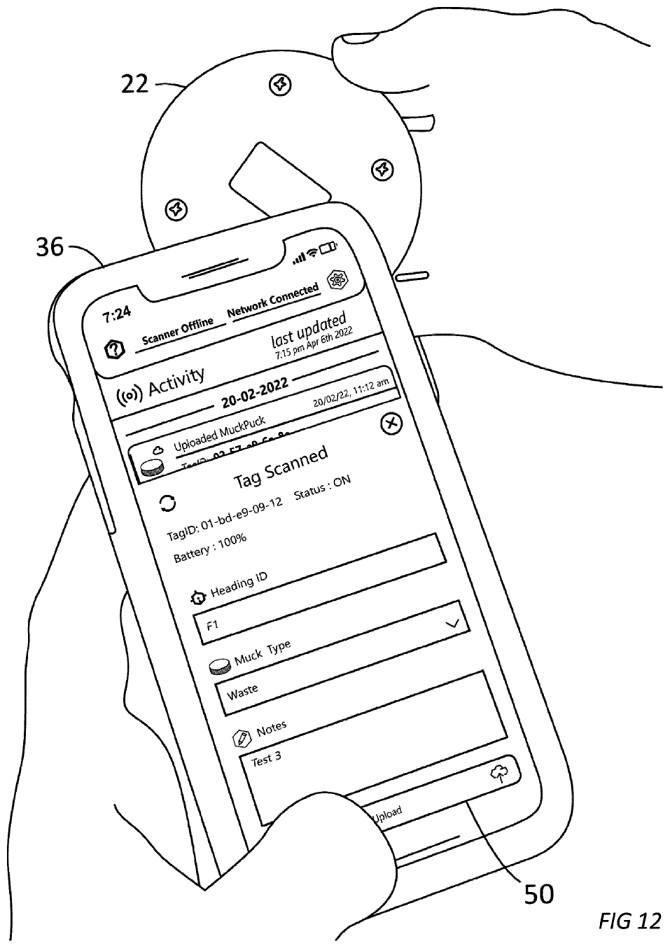

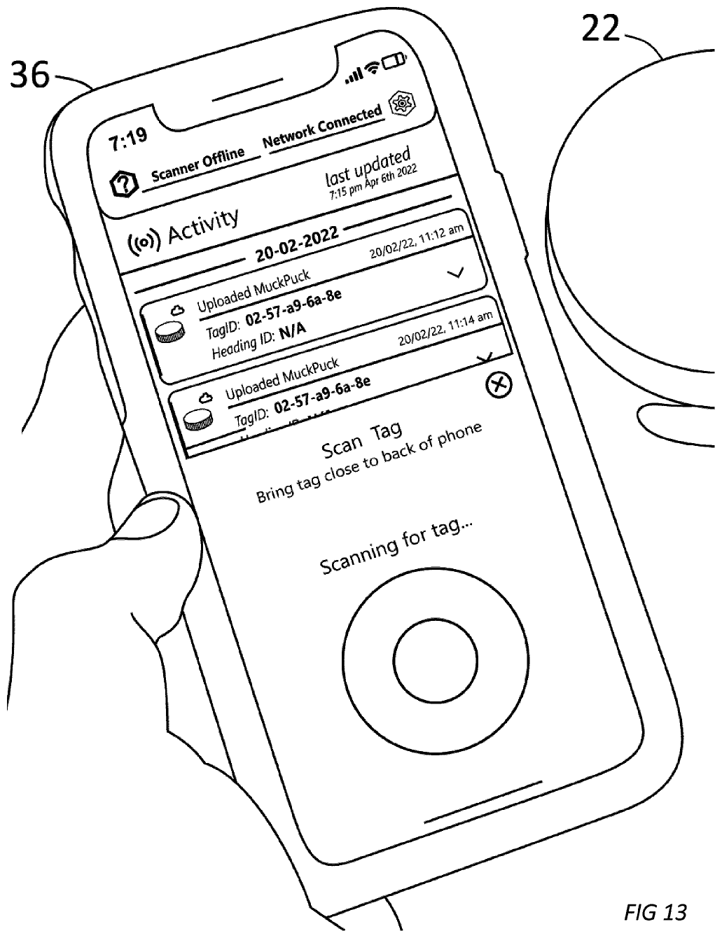

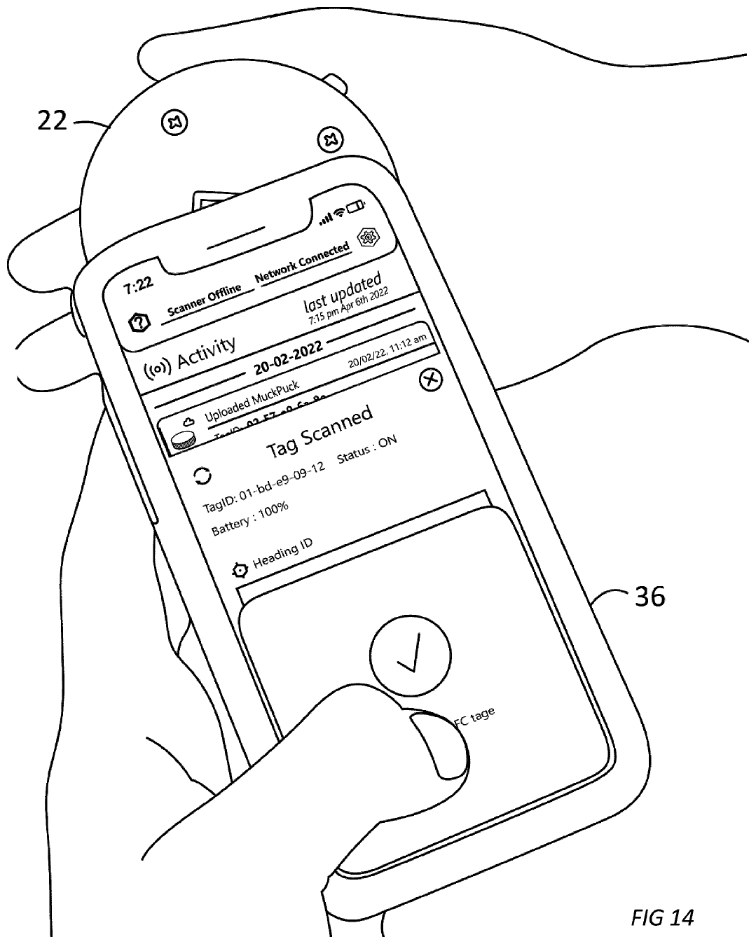

drawing a beacon from storage
bringing a magnet into close contact with the top centre of the device, as indicated by FIG. 8, to activate the device
activating the app on a functionalized phone as required
selecting the “Scan Beacon” function on the app, as shown on FIG. 9
holding the phone near the beacon, as shown in FIG. 10
entering details of the flight and ore type into the app, as shown in FIG. 11
selecting “upload” on the app as shown in FIG. 12
holding the phone near the beacon, as shown in FIG. 13
waiting for the confirmation message on the phone indicating that the beacon has been programmed, as shown in FIG. 14

### Process Control

As illustrated, as each tagged pile traverses zone Z2, the controller therein reads the material type from the WPSN signal and the logic activates the relay to signal the cart operator to the appropriate pathway O or W, depending upon material type.

### Manual Inventory Auditing and Puck Maintenance

In addition to the assignment of beacons to piles at the initial formation and characterization of a pile, handhelds can be used throughout the mine to scan piles for audit purposes, i.e. to ensure that piles are appropriately tagged. The harsh conditions to which the beacons are exposed will result in destruction from time to time. In these circumstances, a new beacon can be activated and deposited in the pile in the manner indicated previously.

In some cases, the nature of the pile will become evident to mine staff upon a review of the inventory, i.e. when a pile at a location has no active beacon and the inventory suggests the presence of a pile with a beacon, it will be evident that the previous beacon was destroyed or lost and a new beacon, with the same details as the prior, can be activated. In other situations, it may be necessary to recharacterize the pile.

Similarly, if the battery life reading of a beacon suggests imminent failure, a new beacon, with the same details as that about to lose functionality, can be activated and deposited.

In all cases, the system will record the details of the change including time and user.

### Variations

Whereas a specific system, mine and use is herein illustrated, it will be evident that variations are possible. For example, whereas:
WPSN uses randomization to avoid signal collision, other systems could be employed.
WPSN is specified, other protocols, such as LoRaWAN, LTE, WiFi, Bluetooth, Bluetooth Low Energy, SixFox, Zigbee could be used
the beacons communicate with the phones via Bluetooth and NFC, other modalities, such as WiFi, could be used
the beacons can communicate with each protocols such as LTE, WiFi, Bluetooth, Bluetooth Low Energy, SixFox, and Zigbee.
only a few headings are shown, the mine could have thousands of flights, zones, and levels
multiple pucks can be deposited in each pile, to safeguard against destruction
in the described embodiment, the type field is ore or waste, the type field need not be so limited and could be customized include, for example, gold, silver, mixed, on call, low grade materials, or investigate
handhelds are provided and communicate with smart phones, it will be evident that custom hardware could be produced embodying the requisite functionality
the periods between signals emitted by the beacon can vary and set by a user for individual beacons or in bulk
the magnet switch and default low power state could be omitted
the readers and controllers can be battery powered
information gathered by the readers and controllers can be communicated to the server otherwise than by local connection to the internet; for example, the phones could be functionalized to periodically gather data when in proximity to the readers and controllers and to upload it to the server when the phone next attains internet connectivity
the relay could be used to trigger devices other than signal lighting such as a conveyor belt, or sound alerts
devices having functionality similar to handhelds could be hardwired to carts
the illustrated display system shows a simple diagram, the layout could of course vary
a server and keyboard are shown, the server could be a cloud server
a subsurface private cell tower is shown, surface cell coverage would also often be used
OFF command to convert the beacon from low power mode to ultra-low power mode can be sent through the NFC antenna via the NFC transceiver or any other signal that the beacon microcontroller can receive, whether wireless or wired.
the readers and controllers can be powered via battery, Power-Over-Ethernet (POE), or other power sources such as different DC or AC voltage sources as long as a correct power supply adapter is installed.
a beacon can also to be initiated and associated to a muck pile through semi-automatic and automatic process such as but not limited to embedded systems, programmable logic systems;
a beacon can also be placed on or in a muck pile through a semi-automatic or automatic process such but not limited to autonomous robots remote, smart shovels, remote controlled robotic arms;
the location of NFC scanner on mobile phones may vary;
the system could be deployed in non-mining operations, for example, concrete manufacture
the deposit and assignment of beacons could be automated
the details assigned to a beacon can also be manually updated at the display area

Accordingly, the invention should be understood to be limited only by the accompanying claims, purposively construed.

1. An inventory management system for a mine, the system comprising:
beacons, each beacon being functionalized as follows:
selectively actuable;
has a unique identifier;
when active, adapted to receive a type;
when active and in motion, emits a signal including identifier and received type;
when active, periodically emits the signal;
readers, each reader being functionalized as follows:
receives signals emitted by beacons;
identifies beacons that are determined to have attained a proximity to the reader based upon signals received;
controllers, each controller being functionalized as follows:
receives signals emitted by beacons;
identifies beacons that are determined to have attained a proximity to the controller based upon signals received;
has a programmable logic;
has a relay responsive to the logic and the signals received;
a display system functionalized as follows:
displays zones, each zone being associated with a reader or a controller;
displays active beacons in each zone, the entry of a beacon into a zone being associated with that beacon having been determined to have attained the proximity to the reader or controller associated with that zone;
displays active beacons not in a zone; and
a connectivity system functionalized as follows:
adapted to receive from the controllers and the readers the identifiers of the beacons determined to have attained proximity thereto and deliver same to the display;
adapted to permit a user to associate a type and a location to an identifier; and
adapted to write a type to a beacon.

2. The system according to claim 1, further comprising handhelds, each handheld being functionalized as follows:
receives signals emitted by beacons;
identifies beacons that are determined to have attained a proximity to the handheld based upon signals received.

3. The system according to claim 2, wherein the connectivity system includes:
an app, the app in use functionalizing phones.

4. The system according to claim 3, wherein the app functionalizes phones to adapt the phone to permit a user to write the type to the beacon as aforesaid.

5. The system according to claim 3, wherein the app functionalizes phones to adapt the phone to permit a user to associate a type, a location and notes to an identifier.

6. The system according to claim 3, wherein the app functionalizes phones to adapt the phone to permit a permit a user to associate a type, a location and notes to an identifier via manual entry to the phone and subsequent transmission by internet to the display system.

7. The system according to claim 3, wherein the app functionalizes phones to adapt a phone to receive from a hand held details of the beacons identified to have attained proximity thereto;
display the details of the beacon on the phone;
permit a user to store an updated location of the beacon; and
deliver the updated location of the beacon to the display system.

8. The system according to claim 1, wherein the beacon is actuable by a magnet.

9. The system according to claim 1, wherein the beacon has a low power state, an active state and a magnet switch and is adapted such that, when a magnet attains proximity to the magnet switch when beacon is in the low power state, the beacon converts to the active state.

10. The system according to claim 1, wherein the signal further includes a battery strength.

11. The system according to claim 1, wherein the readers and controllers are further functionalized to filter and control the flow of received beacon data.

12. The system according to claim 1, wherein the display system is further functionalized to display beacon detail change history.

13. The system according to claim 1, wherein the connectivity system is further functionalized to permit an authorized user to change beacon details are association.
